(19) United States
(12) Patent Application Publication
(10) Pub. No.: US 2008/0072250 A1
(43) Pub. Date: Mar. 20, 2008

(54) APPARATUS, SYSTEM, AND METHOD FOR DISTRIBUTING DIGITAL MEDIA INFORMATION

(76) Inventors: Daniel Osorio, Deer Mountain, UT (US); Randall Wayne Larson, Heber City, UT (US); Sean Zachary Thayne, Riverton, UT (US)

Correspondence Address: Kunzler & McKenzie, 8 EAST BROADWAY, SUITE 600, SALT LAKE CITY, UT, 84111, US

(21) Appl. No.: 11/856,013

(22) Filed: Sep. 14, 2007

Related U.S. Application Data
(60) Provisional application No. 60/825,826, filed on Sep. 15, 2006.

(51) Int. Cl. H04N 7/10

(52) U.S. Cl. 725/34

(57) ABSTRACT

An apparatus, system, and method are disclosed to distribute digital media information to an end user through individual modules. The invention includes a central networked data point controlling access to and manipulation of the digital media information for display at an end user display and one or more content modules, the one or more content modules providing access to digital media information at the end user display. Also included are a framework module configured to assemble the one or more content modules into a framework definition forming a graphical user interface (GUI) for the end user display and a framework modification module configured to selectively include content modules in the framework definition. Beneficially, such an apparatus, system, and method would allow for the distribution of digital media along with easy modification of the type and configuration of the media displayed.

### CROSS-REFERENCES TO RELATED APPLICATIONS

This application claims the benefit of U.S. Provisional Patent Application No. 60/825,826 entitled “Media Distribution System and Method” and filed on Sep. 15, 2006 for Daniel Osorio, which is incorporated herein by reference.

### BACKGROUND OF THE INVENTION

1. Field of the Invention

This invention relates to the distribution of digital media information and more particularly relates to data structures that store, process, transmit, and receive digital media information in a manner which allows an end user to access individually programmed information easily.

2. Description of the Related Art

The delivery of media is in great demand. Operators of various types of multiple dwelling units (MDU's) such as hotels, hospitals, apartment complexes, and municipalities wish to deliver media to many end users while keeping the costs of deployment and programming down and creating income opportunities. These operators turn to media delivery systems to lower costs and capitalize on opportunities.

Existing media delivery systems are proprietary, closed systems that address a specific set of issues and use specific technologies. Often, the nature of the costs and opportunities facing MDU operators change more quickly than the lifetime of the delivery systems. Since the existing systems are limited to the functionality implemented at the time of installation, operators cannot easily modify the systems to further reduce costs, capitalize on new opportunities, or deploy new types of content.

In addition, existing systems rely on special-purpose control devices located at the end user display locations to drive a display. These special-purpose control devices lack the flexibility required to display new types of media, regardless of the delivery system. As a result, an operator is required to change the entire system, including a large number of special-purpose control devices, in order to change functionality at the display location.

### SUMMARY OF THE INVENTION

From the foregoing discussion, it should be apparent that a need exists for an apparatus, system, and method for distributing digital media information that has the flexibility to accommodate new types and arrangements of media. Beneficially, such an apparatus, system, and method would allow for the distribution of digital media along with easy modification of the type and configuration of the media displayed.

The present invention has been developed in response to the present state of the art, and in particular, in response to the problems and needs in the art that have not yet been fully solved by currently available media distribution systems. Accordingly, the present invention has been developed to provide an apparatus, system, and method for distributing digital media information that overcome many or all of the above-discussed shortcomings in the art.

The apparatus to distribute digital media information is provided with a plurality of modules configured to functionally execute the necessary steps of distributing digital media. These modules in the described embodiments include a central networked data point controlling access to and manipulation of the digital media information for display at an end user display and one or more content modules, the one or more content modules providing access to digital media information at the end user display.

In one embodiment, the apparatus includes a framework module configured to assemble the one or more content modules into a framework definition forming a graphical user interface (GUI) for the end user display and a framework modification module configured to selectively include content modules in the framework definition.

The central networked data point and the end user display of the apparatus, in one embodiment, engage in bidirectional communication. In another embodiment, the apparatus includes a property server comprising an access management module configured to manage access and manipulation of the digital media information for display at an end user display. The property server, in one embodiment, includes a content storage module configured to store digital media information for display at an end user display. In one embodiment, the property server is configured to service one or more end user displays, the one or more end user displays exclusively located at a multiple dwelling unit (MDU). In an alternate embodiment, the property server further comprises a content distribution module configured to distribute a portion of a title of digital media content to another property server using a peer-to-peer protocol. In certain embodiments, the property server cooperates with a plurality of property servers to distribute the digital media content.

A system of the present invention is also presented to distribute digital media information to an end user through individual modules. The system may be embodied by a network operations center (NOC), a property server, and a set top box (STB). In particular, the system, in one embodiment, includes a NOC controlling access to and manipulation of the digital media information and a property server servicing one or more end user displays, the one or more end user displays exclusively located at a multiple dwelling unit (MDU), the property server in bidirectional communication with the NOC.

The system may further include a property server configured to receive digital media information from the NOC, transmit usage data to the NOC, transmit digital media information to a set top box (STB), and receive media requests from the STB. In certain embodiments, the STB is configured to retrieve a framework definition comprising one or more content modules from the property server and display a graphical user interface (GUI) providing user access to the content modules in the framework. The STB may further transmit media requests to the property server and display the digital media information accessed by the content modules.

In one embodiment of the system, NOC and the property server communicate over the Internet using a virtual private network (VPN). In another embodiment, the STB retrieves the framework definition from the property server in response to each content display request.

A computer program product comprising a computer readable medium having computer usable program code executable to perform operations for distributing digital media information to an end user through individual modules is also provided. The operations of the computer program product, in one embodiment, include accessing a dynamic framework definition in response to each content display request, the dynamic framework definition defining a graphical user interface (GUI), the dynamic framework definition accessed from a property server configured to service one or more end user displays, the one or more end user displays exclusively located at a multiple dwelling unit (MDU).

In one embodiment, the operations of the computer program product include interpreting the dynamic framework definition to determine the presence and position of one or more content modules, rendering a display comprising one or more content modules, and accessing digital media information in response to the activation of a content module. The operations of the computer program product, in another embodiment, include accessing a second dynamic framework definition in response to the activation of a content module, the second dynamic framework definition accessed from the property server.

In an alternate embodiment, the operations of the computer program product include displaying a partially retracting hierarchical menu wherein the partially retracting hierarchical menu retracts to display only two or more bottom levels of a menu hierarchy. The operations for the partially retracting hierarchical menu may also include extend the menu to display three or more levels of a menu hierarchy in response to highlighting an element of the partially retracting hierarchical menu.

In one embodiment of the computer program product, accessing digital media information includes decrypting the digital media information using a decryption key. In another embodiment, the dynamic framework definition is an extensible markup language (XML) document. In another embodiment, each of the one or more content modules is selected from the group consisting of a digital content player, a link to a second dynamic framework definition, an interactive application, an input screen, and a text display screen.

A method of the present invention is also presented for distributing digital media information to an end user through individual modules. The method in the disclosed embodiments substantially includes the steps necessary to carry out the functions presented above with respect to the operation of the described apparatus and system. In one embodiment, the method includes delivering a framework to an end user display comprising one or more content modules and delivering a content module to an end user, the content module configured to display video content in response to activation by the end user. The method also may include streaming the video content to the end user in response to activation of the content module by the end user and selecting a position for an advertisement in the video content. In certain embodiments, the method includes selecting the advertisement based on demographic information and injecting the advertisement into the streamed video content.

In a further embodiment, the method includes receiving demographic information relating to the end user, and wherein selecting the advertisement based on demographic information further comprises selecting the advertisement based on demographic information relating to the end user. In another embodiment, selecting an advertisement based on demographic information further comprises selecting the advertisement based on information relating to the location of the end user display. In yet another embodiment, selecting an advertisement based on demographic information further comprises selecting the advertisement based on information relating to the video content.

Selecting a position for an advertisement, in one embodiment, further comprises receiving input from an administrator indicating a desired position for the advertisement in the video content. In another embodiment, streaming the video content to the end user is in response to an activation confirmation by the end user. In certain embodiments, activation confirmation is selected from the group consisting of input of a personal identification number (PIN), a credit card number, a swipe of a credit card in a credit card reader, and a swipe of a room key in a room key reader.

An apparatus to distribute digital media information to an end user through individual modules is provided. The apparatus, in certain embodiments, includes a central networked data point controlling access and manipulation of the digital media information for display at an end user display and one or more content modules, the one or more content modules providing access to digital media information at the end user display, wherein the each of the one or more content modules is selected from the group consisting of a digital content player, a link to a second dynamic framework definition, an interactive application, an input screen, and a text display screen. In one embodiment the apparatus includes a framework module configured to assemble the one or more content modules into a framework forming a graphical user interface (GUI) for the end user display and a framework modification module configured to selectively include content modules in the framework.

In one embodiment, the apparatus includes a browser interface configured to accept input from an administrator and a content module library configured to contain references to one or more content modules, the references configured to be added to the framework in response to input by the administrator. In another embodiment, the apparatus includes a content module removal module configured to remove a content module from the framework in response to input by the administrator. In yet another embodiment, the apparatus includes a content module modification module configured to create a content module in response to input by the administrator.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of distribution of digital media content from a network operations center (NOC) to one or more multiple dwelling units (MDUs) in accordance with the present invention;

FIGS. 2, 3, and 4 are schematic block diagrams illustrating embodiments of a graphical user interface (GUI) according to the present invention;

FIG. 5 is a schematic block diagram illustrating one embodiment of a print system according to the present invention;

FIG. 6 is a schematic block diagram illustrating one embodiment of a data transfer system according to the present invention;

FIG. 7 is a schematic block diagram illustrating one embodiment of a GUI admin system according to the present invention;

FIG. 8 is a schematic block diagram illustrating one embodiment of a system for distributing digital media according to the present invention;

FIG. 9 is a schematic block diagram illustrating one embodiment of a NOC according to the present invention;

FIG. 10 is a schematic block diagram illustrating one embodiment of a property server according to the present invention;

FIG. 11 is a schematic block diagram illustrating one embodiment of a set top box (STB) according to the present invention;

FIG. 12 is a schematic block diagram illustrating one embodiment of a partially retracting hierarchical menu according to the present invention; and

FIG. 13 is a schematic flow chart diagram illustrating one embodiment of a method for distributing digital media information in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

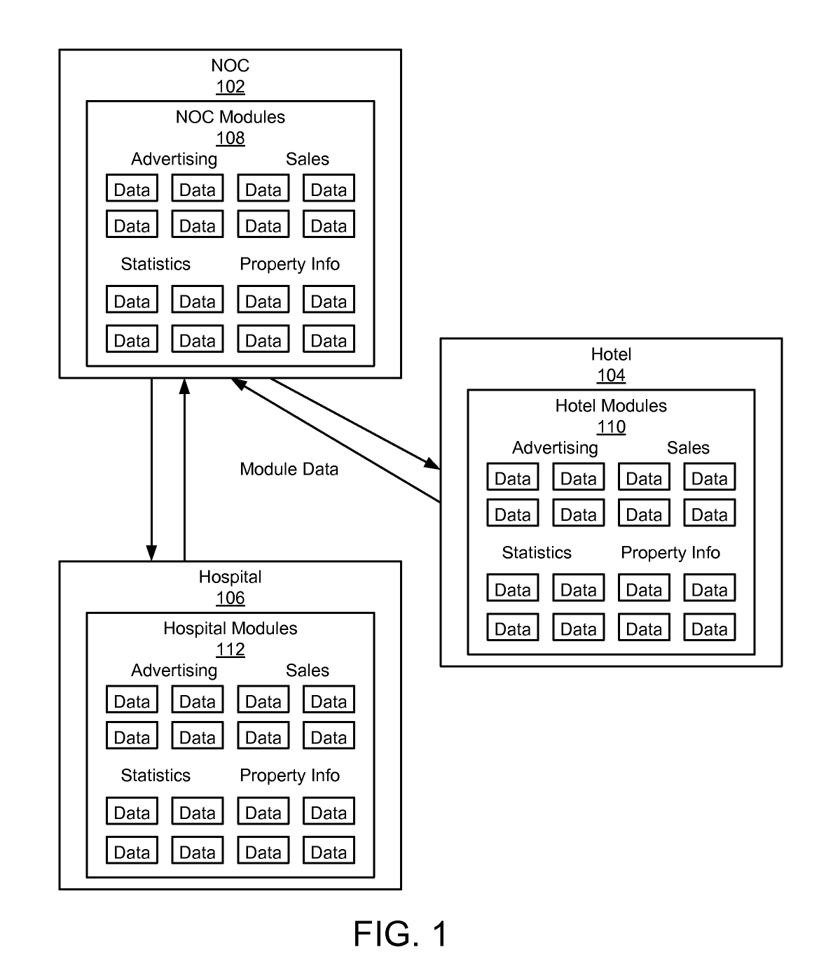

FIG. 1 depicts a network operations center (NOC) 102 containing the main data storage component that is used by all multiple dwelling units (MDUs). As used herein, an MDU may comprise a hotel, hospital, apartment building, condominium complex, gated community, townhome complex, retirement community, university residence hall, fraternity/sorority house, mobile home park, office building, or any other location managed by a single entity where multiple users in different locations will be provided with a set of digital media they can access as desired. FIG. 1 depicts two types of MDUs, a hotel 104 and a hospital, 106 each containing individually customized modules. The NOC 102 is divided into several different objects that control each and every aspect of the data with access control to only allow specific manipulation of the data.

In commercial applications stringent access control of the data storage components may be employed to require limited and specific access to the data. This makes it extremely difficult for intentional or accidental harmful modification of the data. The key data components have the ability to communicate with each other to create the data view that is required to fill the needs of the application. Because of the unique design, the data can be duplicated or replicated across several machines simultaneously. As depicted in FIG. 1, this replication of module data is bidirectional so the MDU can make changes to the data and securely communicate those changes back to the NOC 102. The NOC 102 stores all data including dynamic content for the set-top-boxes, unique advertisements for all properties, account information, deployment information, accounting, billing, support and other miscellaneous actions that have been defined.

At each MDU there is a data storage component that is similar to the one found in the NOC. As depicted in FIG. 1, the NOC 102 includes modules 108 that are similar to the Hotel modules 110 and Hospital modules 112. The key difference between the two data components are the data itself. The data at the MDU is only related to what that specific MDU requires. It does not contain information about any other MDU. The MDU component does not require a connection with the NOC 102 to run properly. It can manage and function totally on its own with little to no noticeable difference to the end user. It stores all data, transactions, and statistics as required and reports the information to the NOC 102 as required.

Updates can also be received via communication with the NOC 102. The NOC 102 will give each MDU instructions on how to fix or update itself. Most of the updates are dynamically generated specifically for each MDU.

In the case of a disaster, the NOC 102 and the MDU can communicate with each other and resynchronize data. In other words, the MDUs can be told how to dynamically fix themselves with little to no human intervention. For example, as shown in FIG. 1, the Hospital MDU 106 contains modules 112 such as Advertising, Sales, Statistics and Property Info relating only to the Hospital requirements and is independent from the Hotel MDU 104.

As illustrated in FIG. 1, the communication between the NOC 102 and MDU is bidirectional. According to one embodiment, the NOC 102 can, at any time, send and receive data relating to the MDU. This is a unique process because most data communications at this level are either one directional or all data is communicated in both directions. In contrast, the communication of the present invention goes in both directions and it is only sending the data that the specific MDU requires.

For example, the Hotel MDU 104 may require only the Sales data relating to the Hotel to be sent from the NOC 102 and not all the Sales data relating to all the MDUs. This enables the two components to function separately on their own in cases of lost connectivity, and then efficiently synchronize as soon as a new connection is made. One of the traits of this data transmission is the ability of multiple MDUs to send and receive information simultaneously to the NOC 102 without duplicating data and wasting bandwidth.

The MDU, in one embodiment, includes an algorithm that takes the incoming data and stores it appropriately with minimal data transfer and overhead. This algorithm takes into consideration the data that has previously been received by the MDU and sends all changes that have been made since the previous transaction.

By way of example, the following highlights one embodiment of the graphical user interface (GUI) 202 of the application, explaining its abilities and features for delivering information to the user. Viewable on a television screen, the GUI 202 allows the user to interact with different sets of information, termed “modules” herein. The present invention is not limited to any one particular GUI. One of ordinary skill in the art would recognize and understand the principles utilized in this embodiment and understand that these modules are infinitely expandable, allowing the application to be completely customized depending on the client's needs. In addition, these modules can pull their information from a number of different sources, outlined below in more detail.

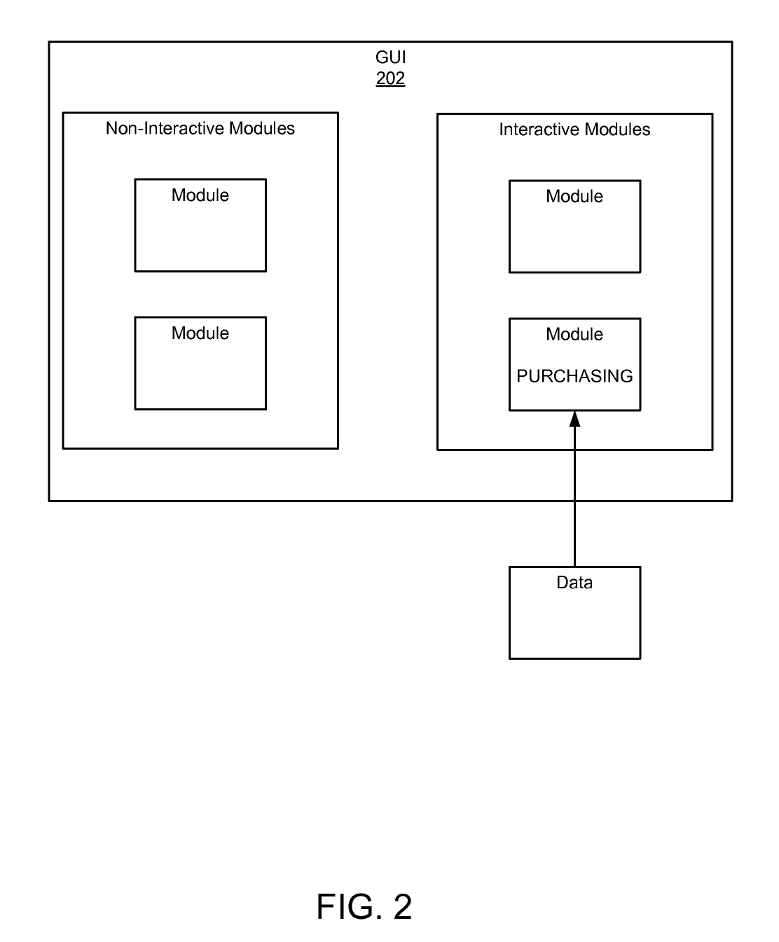

Each MDU may have its own customized GUI 202 implementing its own unique functions and features. The following functions and features will be described with reference to FIGS. 2, 3 and 4.

FIG. 2 illustrates one embodiment of a GUI 202. The GUI 202 has the ability to display interactive and non-interactive information. Examples of interactive information include, but are not limited to a shopping area, advertising that gives you the option to buy the product immediately, or an e-learning course that tracks your progress. Examples of non-interactive information include, but are not limited to advertising without the ability to select it for more information, the weather, or a calendar of events for the area.

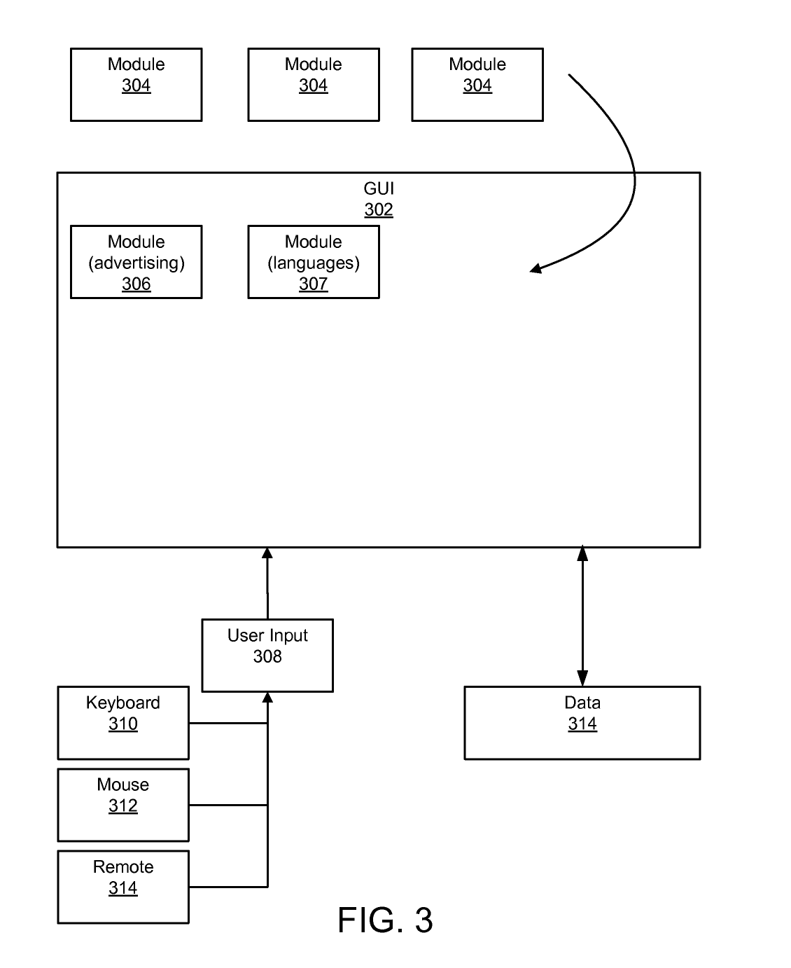

FIG. 3 illustrates another embodiment of a GUI 302. As depicted in FIG. 3, by using a user input 308, such as a mouse 310, keyboard 312, or simple television remote 314, the user can navigate through the entire application, accessing and responding to information as it is received. All the sections of the application may be easily navigated to using a combination of uniquely designed moveable menus. If the user is responding to an interactive module, input can be received by typing on a keyboard 312 or moving around a keypad module on the screen using the arrow keys and enter button on a remote 312 or a computer mouse 314.

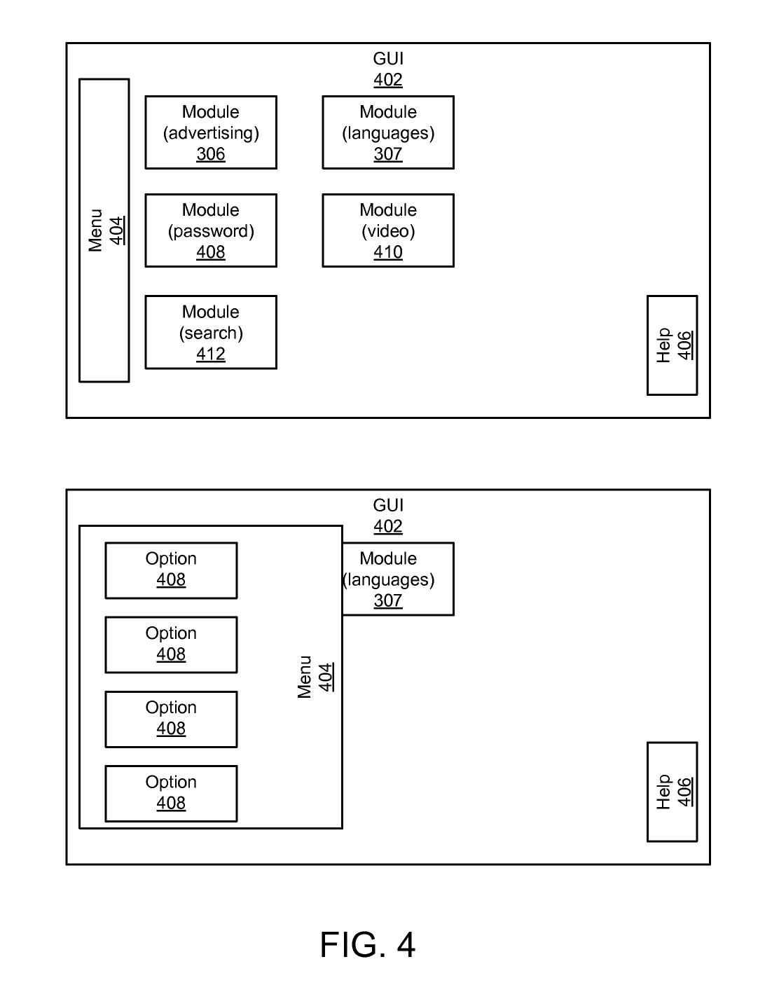

As shown in FIG. 4, in one embodiment of the invention, the navigation in a GUI 402 includes expandable and moveable menus 404. Both these features allow the user to quickly access any module 306, 307. When the user navigates to a closed menu 404, it automatically reveals itself as an expanded menu 406 and allows the user to navigate around its options 408. When a module 306, 307 has more information than can be displayed on one page, the menu 404 will automatically scroll to more options depending on where the user navigates to.

These two features allow for a more intuitive experience and the ability to display more information in a smaller space than could be delivered through a simple static navigational system. In addition, as shown in FIG. 3, any module 304 can also link to any other module, allowing for a truly integrated experience. An example of this could be that after ordering a movie, the user is directed to options for ordering food to accompany the show or to some type of advertising associated with the selection or the choice of language.

When accessing the specific data for a module, the application has the ability to obtain its information from many different sources. Examples of this could include a hotel's demographic information on its guests, a movie stored on computers at the property, or ordering takeout from a restaurant via the internet. Similar in the ability to create an infinite number of different modules, the information accessed by the user could be obtained in a number of different ways, limited only by technology's current information sharing capabilities.

In one embodiment, modules 304, 306, 307, such as modules 304 illustrated in FIG. 3, are the main component of the application. The features listed below, such as for example, advertising, multi-lingual support, password protection, custom experience, screen saver, purchasing, help, search, etc. are a type of module. These updateable sections can take on any number of forms.

In its simplest form, a module 304 can display information to the user. In a more complex form, a module 304 can be a mini application on its own. For instance, one module 304 could be an entire word processing application.

New modules 304 may constantly be created to meet the needs of the clients. The complexity of each module 304 is only limited by the computer on which the GUI 302 resides and the current limitations by software development in general. As shown in FIG. 3, the module 304 is loaded into the main core GUI 302 and then, depending on its properties, it will receive and possibly send data 314 to various data sources by way of the main GUI 302.

As shown in FIG. 3, as part of the main GUI 302, advertising is another type of module 306. The advertising module 306 can take on many different forms. The simplest of which could be a static image with no interactivity. This type of ad is comparable to a print ad in a magazine or newspaper. At a more complex level, the ad could be a video with the option to select it, resulting in either a larger full screen ad or more information about the ad in the form of a module. At a more complex level, an ad could be called depending on user input within a module. An example of this would be the user playing a certain musician's album causing an ad to appear which gives the user the option to buy that album.

As shown in FIG. 3, as part of the main GUI 302, language is another type of module 307. The application has the ability to support virtually all languages. These languages are also customizable to the property that the application resides. This means that each property can choose the languages that best fit the needs of its clients, providing yet another level of customization. The fonts needed for the different languages may be loaded in the beginning on startup.

A module can be protected by a user defined password. As shown in FIG. 4, as part of the main GUI 402, another type of module is password protection 408. This adds a level of security for things such as parental locks or personal information. Hence, as shown in FIG. 4, parental module interacts with the password module 408. With many modules different levels of security can be set so that inappropriate information doesn't make it into the hands of the wrong person.

Much of the input that the user gives to the application can be used to customize the experience to that individual user. From advertisements focused on the users choices to musical playlists set up by the user, the application is not only customized to the property in which it resides, but also to the individual user and their choices. Hence, for example, a customized experience module can be created storing personalized data for each individual user obtained based on the user input 308.

When the user is no longer interacting with the application, it will begin a screen saver, another type of module. This screen saver can be used to display a variety of information. Advertisements could run during this time, but this space could also be used for either community or property specific information.

Not only is every application customizable to the specific property, but modules 304 can easily be updated with more recent versions without redeploying the entire application. This means that the application, in one embodiment, will always be checking for the most recent version of a module 304 and automatically update itself with the newer module. This technology also allows new modules 304 to be added and automatically included as they are deployed without redeploying the entire application.

The GUI 402 has the ability to support virtually all types of media, whether it is audio, video, images, or text. Not only are these displayable in the GUI 402, but each type of media also has the ability to be interactive. Video presenting information about a point of interest in the area, if selected by the user, could launch a video module 410 showing a video about the spot. As illustrated in FIG. 4, a video module 410 may be part of the GUI 402.

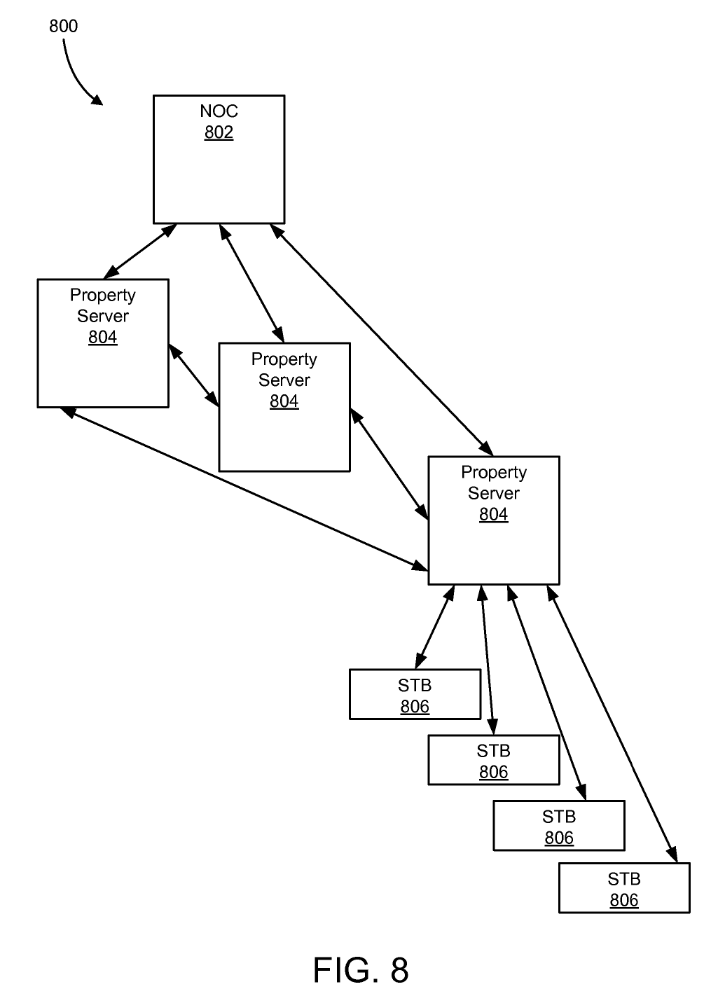

Many of the interactive modules 304 allow the user to purchase items. These products can take on many forms and be delivered in many ways. A user could order a movie that would be pulled from a property server (described in relation to FIG. 8) on the site of the property immediately. Another option could be clothing ordered and sent to an address determined by the user. A final type of purchase would be information created for the client in a material form on location. An example of this would be a CD of music organized by the user and burned at a central location on the property. Purchases can also be time dependent such as buying internet access for a limited time. The GUI 402 gives users access to these time dependent purchases in a module so that they can easily resume the activities they have purchased.

As shown in FIG. 4, as part of the main GUI 402, help 406 is another type of module. The help section, in one embodiment, is always available to the user. Depending on the module the user is currently navigating, the help module 406 will display a video pertinent to that module. This allows the user to quickly access the information necessary to alleviate their current problem.

As shown in FIG. 4, as part of the main GUI 402, search 412 is another type of module. Much of the information that the GUI accesses can be searched by various search modules 412 in one embodiment. These search modules 412 can take various forms, but they all function to help the user quickly find information relating to data pertaining to the module. This customized searching eliminates many dead ends that would appear with a more generalized search option.

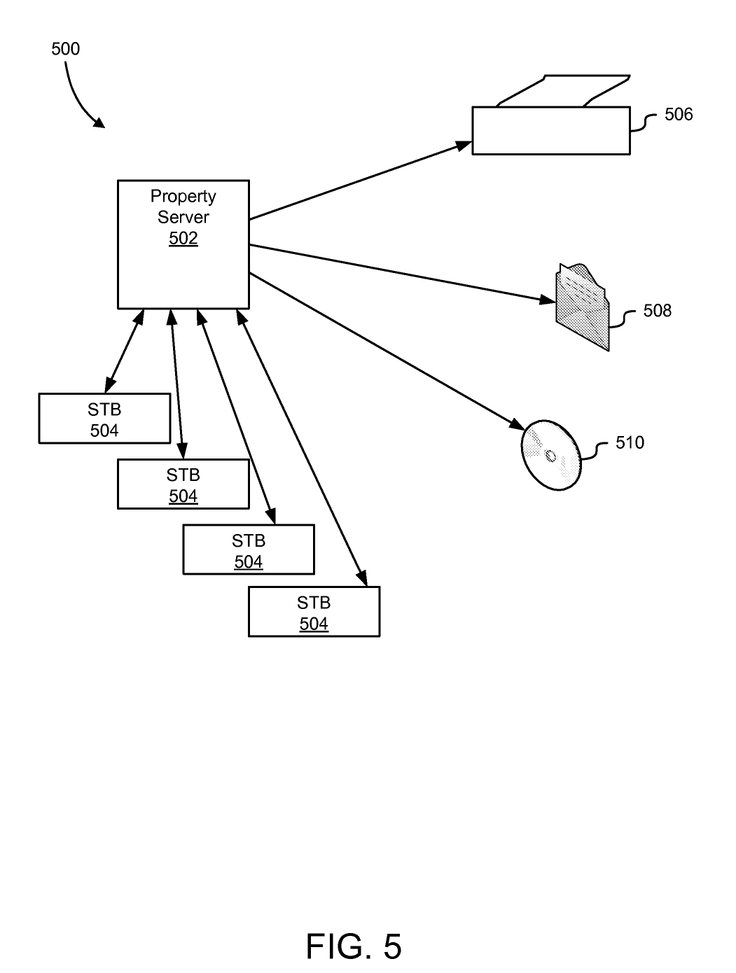

One embodiment of a print system is illustrated in FIG. 5. On startup of the GUI, the GUI pulls a feed from the property server 502 containing the prices of printing. With reference to FIG. 5, when a set top box 504 prints, it stores the print job remotely at the property server 502. From the property server 502, the file can be printed to a physical printer 506, emailed digitally 508, or transferred to a storage medium 510, such as an optical disc or a digital media card.

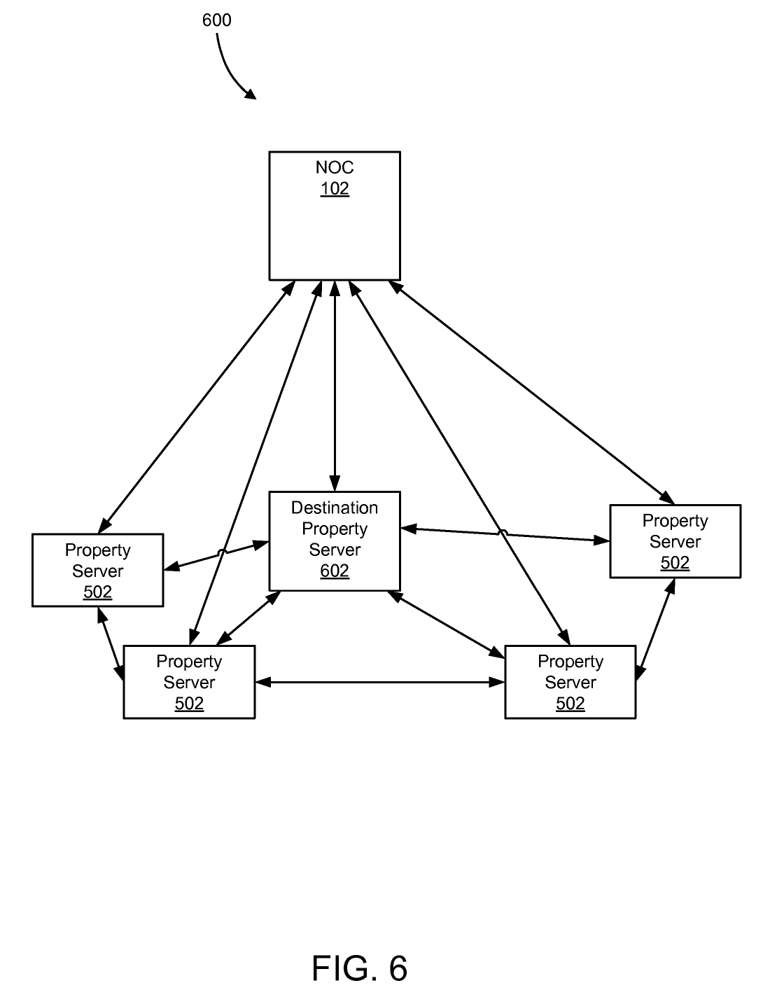

One embodiment of a data transfer system 600 is illustrated in FIG. 6. The data transfer system 600, in the illustrated embodiment includes a NOC 102, a destination property server 602, and a one or more additional property servers 502. The data transfer system 600 transfers data to destination property server 602. The transferred data may include, but is not limited to, content modules and other digital media content, such as movies, music, or the like.

In certain embodiments, the NOC 102 transfers an install script to the destination property server 602 containing information on the data to be transferred. This install script contains a file with information on where the actual file is located and where the destination property server 602 can obtain it from. In addition, this script may contain instructions to be used after the data has been transferred. The data instructions may contain information on what to do to the data that has just been transferred as well as access control data enabling clients to obtain access to the information. In addition, this file may contain information on how to remove this data in the future.

In one embodiment, the destination property server communicates with and receives data from additional property servers 502 using a peer-to-peer protocol. The destination property server 602, in this embodiment, grabs pieces of the data from either the NOC 102 or from the additional property servers 502 which also have the data to be transferred. An example of a peer-to-peer transfer protocol is BitTorrent™.

By using a peer-to-peer transfer protocol, the overall load on individual data connections is reduced. For example, rather than sending a new movie release to all property servers 502 individually, the NOC 102 can distribute pieces of the file containing the movie to the individual property servers 502. The individual property servers 502 may then transfer the pieces of the file to the other property servers 502 to complete the file at all of the property servers 502. In this example, the network load is distributed between many connections, rather than the relatively large network load on the NOC 102 connection required if the movie file were distributed to the property servers 502 individually.

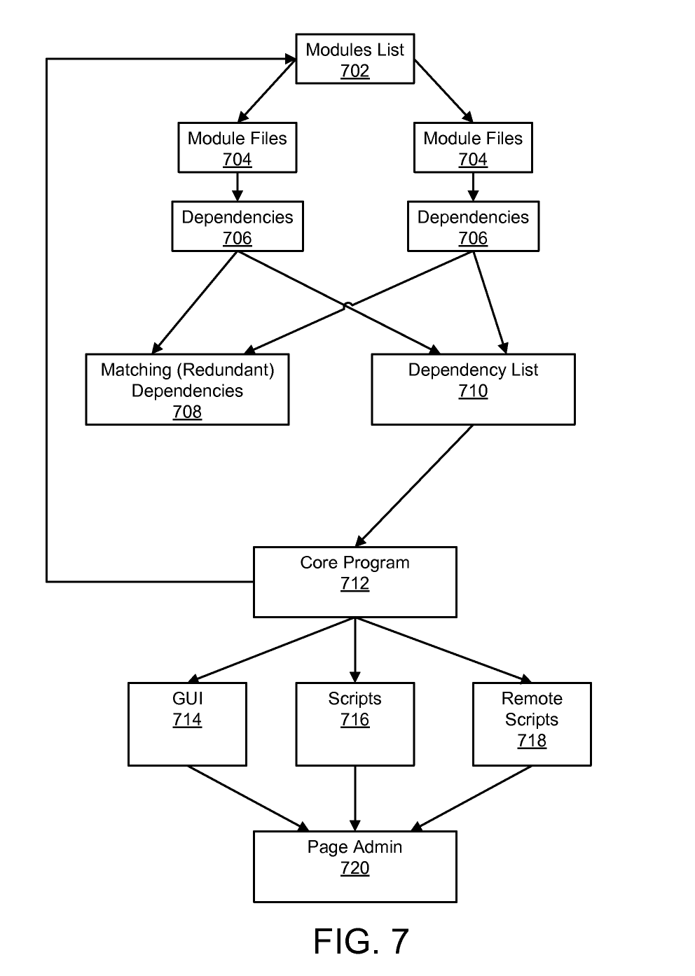

One embodiment of a GUI administration system is illustrated in FIG. 7. With reference to FIG. 7, the core program 712 grabs list 702 of all the needed modules 704. Then the core program determines dependencies 706 (GUI dependency and Script dependency) of each module 704. After determining dependencies 706 the core program concatenates duplicate dependencies 708, and builds dependency list 710 for the core program 712. Then the core program 712 builds the GUI 714, local scripts 716, and remote scripts 718, such as AJAX or the like, to build the GUI Page Admin 720.

The Page Admin 720, in one embodiment, allows administrators/managers the ability to add/modify/delete their custom GUI and products, as well as multilingual editing. In one embodiment, modules 704 in the GUI 714 have a counterpart in the Page Admin 720 to manipulate that module 704.

FIG. 8 illustrates one embodiment of a system 800 for distributing digital media. The system 800 includes a NOC 802, one or more property servers 804, and one or more set top boxes 806. The system 800 distributes digital media to the set top boxes (STBs) 806 using modules.

The NOC 802, in one embodiment, controls access to and manipulation of digital media information. In the illustrated embodiment, the NOC 802 engages in bidirectional communication with one or more property servers 804. The NOC 802 receives information including but not limited to media requests by end users, billing information from end users and properties, performance data, error data, and the like. In addition, the NOC 802 communicates information to property servers 804 and STBs 806 including, but not limited to new frameworks, modified frameworks, content modules, digital media information, pricing information, and the like.

In one embodiment, the one or more property servers 804 duplicate many of the processes of the NOC 802. An individual property server 804 may control access to and manipulation of digital media information by an end user through an STB 806. The individual property server 804 may synchronize with elements of the NOC 802, updating the contents of the property server 804 in response to changes of elements of the NOC 802.

The one or more property servers 804, in one embodiment, engage in bidirectional communication with the NOC 802. The one or more property servers communicate with the NOC 802 as described in relation to the NOC 802 above in one embodiment. In certain embodiments, the one or more property servers 804 aggregate data for batch transmission with the NOC 802. For example, several STBs 806 may purchase and stream digital content from a property server 804 over a period of time. The property server 804 may aggregate the purchasing information for these purchases over the period of time and transmit a batch of purchasing information to the NOC 802.

In addition, a property server 804 may repeat messages from an STB 806 intended for the NOC 802. For example, an STB 806 may request an encryption key from the NOC 802 by transmitting the request to the property server 804. The property server may then repeat that request in a transmission to the NOC 802. The reverse may also occur. The property server may repeat messages from the NOC 802 intended for an STB 806.

In the illustrated embodiment, the one or more property servers 804 each engage in bidirectional communication with one or more STBs 806. The property server 804 receives information including but not limited to media requests by end users, billing information from end users and properties, performance data, error data, and the like from the one or more STBs 806. In addition, the property server 804 communicates information to STBs 806 including, but not limited to new frameworks, modified frameworks, content modules, digital media information, pricing information, and the like.

The one or more STBs 806, in one embodiment, engage in bidirectional communication with a property server 804 and the NOC 802. An STB may receive input from an end user and display a graphical user interface (GUI). An individual STB 806 receives a framework from a property server 804 that indicates the position of one or more content modules to form the GUI.

In certain embodiments, the one or more STBs 806 receive requests from end users to access content modules. An STB 806 may transmit a request to the property server 804 to access a content module. In one embodiment, the property server 804 may transmit a content module to the STB 806 in response to the request. In another embodiment, the property server 804 may pass the request to the NOC 806 for approval.

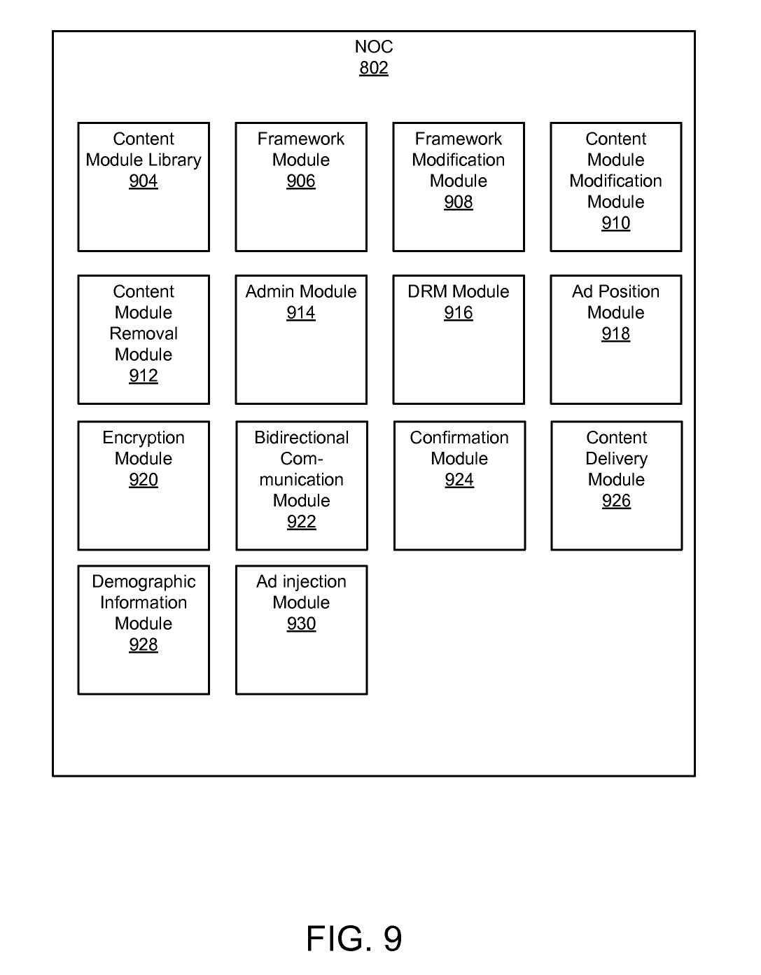

FIG. 9 illustrates one embodiment of a NOC 802. The NOC 802 in the illustrated embodiment includes a content module library 904, a framework module 906, a framework modification module 908, a content module modification module 910, a content module removal module 912, an admin module 914, a digital rights management (DRM) module 916, an ad position module 918, an encryption module 920, a bidirectional communication module 922, a confirmation module 924, a content delivery module 926, a demographic information module 928, and an ad injection module 930. The NOC 802, in one embodiment, controls access to and manipulation of digital media information.

The content module library 904 contains references to one or more content modules in one embodiment. The content module library 904 provides access to digital media information available for distribution to end users. The content modules contained in or referenced by the content module library 904 may include, but are not limited to, digital content players, such as a video player, a link to another content module, a framework definition, an interactive application, such as a word processor or a web browser, an input screen, a text display screen, an interactive module, a non-interactive module, or the like.

The framework module 906, in one embodiment, assembles one or more content modules into a framework definition. The framework module 906 accesses the content module library 904 to allow an administrator or a process to select content modules for inclusion in the framework. The framework module 806 stores the assembled framework in the content module library 904 in one embodiment.

The framework contains information defining how content modules are displayed in a GUI, such as the position and properties of the displayed content module. The framework may comprise any type of object capable of defining how content modules are displayed. For example, in one embodiment, the framework comprises an extensible markup language (XML) document.

The framework modification module 908, in one embodiment, selectively includes content modules in a framework in response to input from an administrator or process. In certain embodiments, the framework modification module 908 includes an interface that receives input from an administrator. For example, the framework modification module 908 may comprise a browser interface. The browser interface may include a drag and drop GUI allowing the administrator to drag content modules to the framework, to move modules within the framework, and to drag content modules from the framework.

In one embodiment, the content module modification module 910 allows an administrator to selectively modify a content module. For example, a content module that includes a description of a property may be modified through the content module modification module 910 to change the description of the property. In another embodiment, the content modification module 910 creates a new content module in response to input from an administrator or process. For example, the content module modification module 810 may provide an interface for creating and adding elements to an interactive content module and add the new content module to the content module library 904.

The content module removal module 912, in one embodiment, removes a content module from a framework in response to input from an administrator or process. For example, a framework may include a content module indicating a special price for menu items at a restaurant at a property. The content module may include an expiration date that triggers a process to activate the content module removal module 912 to remove the content module from the framework on the expiration date.

In another embodiment, the content module removal module 912 removes a content module from the content module library 904. For example, an administrator may conclude that a content module is no longer useful, and activate the content module removal module 912 to remove the content module from the content module library 904.

The admin module 914, in one embodiment, allows an administrator to access the modules of the NOC 802. In one embodiment, the admin module 914 allows access in response to a security credential, such as a password. The admin module 914 may provide a GUI for access to modules of the NOC 802. In one embodiment, the admin GUI is a browser interface.

In certain embodiments, the admin module 914 manages access to elements of the NOC 802 at user and group levels. As will be appreciated by one skilled in the art, the admin module 914 may selectively allow access to elements of the NOC based on the access rights of the user or the user's group.

The DRM module 916, in one embodiment, manages access to digital media having access managed by digital rights. For example, a movie may include DRM requirements to limit the playback of the movie to authorized players. In certain embodiments, the DRM module 916 may cooperate with an end user display to allow access to the digital media information in response to a purchase of rights to view the digital media information. In another embodiment, the DRM module 916 may allow display of the digital media information in response to an agreement by an end user to view advertisements with the digital media information.

In one embodiment, the DRM module 916 manages one or more decryption keys used for decrypting encrypted digital media information. For example, an STB 806 may request a decryption key from the NOC 802. In one embodiment, the DRM module 916 determines if the request should be granted, and delivers a decryption key to the STB 806.

The ad position module 918 selects a position for one or more advertisements in a content module in response to input from an administrator or a process. A position for an advertisement may be a location on a static or interactive screen. Additionally, a position for an ad may comprise an elapsed playback time in digital media. For example, an administrator may direct the ad position module 918 to select eighteen minutes and seven seconds as a time in a movie to place an advertisement. In another example, a process may direct the ad position module 918 to select a position in a content module displaying a GUI to an end user to display a banner ad at the top of the GUI.

The encryption module 920, in one embodiment, encrypts digital media information to restrict the display of the information to authorized viewers. The encryption may comprise any encryption method known in the art, such as public key encryption. Encrypted digital media information may require that the player include a decryption key obtained from the DRM module 916.

In one embodiment, the bidirectional communication module 922 manages communication between the NOC 802 and the one or more property servers 804. In certain embodiments, the bidirectional communication module 922 manages communication between the NOC 802 and the one or more set top boxes 806. The bidirectional communication module 922 may use any communication method known in the art, such as an Ethernet connection. In one embodiment, the bidirectional communication module 922 communicates with the one or more property servers 804 via a virtual private network (VPN) over the Internet.

The bidirectional communication module 922, in one embodiment, transmits information including but not limited to media requests by end users, billing information from end users and properties, performance data, error data, and the like. In addition, the bidirectional communication module 922 transmits information to property servers 804 and STBs 806 including, but not limited to new frameworks, modified frameworks, content modules, digital media information, pricing information, and the like.

In one embodiment, the confirmation module 924 receives confirmation from a user to access a content module. Confirmation may take the form of a personal identification number (PIN), a credit card number, the swiping of a credit card in a card reader, a swipe of a room key in a card reader, or the like. By receiving confirmation in conjunction with delivering digital content, the confirmation module 924 reduces the incidence of charge backs. For example, a user may request a pay movie. The confirmation module 924 requires that the user enter a PIN to confirm the purchase of the movie, thus reducing the likelihood of “accidental” purchases and requests for a charge back.

The content delivery module 926 delivers digital media information. In one embodiment, the content delivery module 926 delivers digital media information to one or more property servers 804 for distribution to one or more STBs 806. In an alternate embodiment, the content delivery module 926 delivers digital media information to one or more STBs 806.

In one embodiment, the content delivery module 926 delivers the digital media information to one or more property servers using a peer-to-peer protocol. For example, the content delivery module 926 may deliver a new movie using a BitTorrent™ protocol to a plurality of property servers 804. In another embodiment, the content delivery module 926 may deliver digital media information by streaming digital content. For example, the content delivery module 926 may stream a requested movie for playback by an STB 806.

The demographic information module 928, in one embodiment, receives demographic information. The demographic information may include information about an end user, information about a property, information about content being viewed, or the like. For example, an end user may request a movie, and the demographic information module 928 may receive the age of the user, the zip code of the property where the user is located, and information about the type of movie being viewed.

The demographic information module 928, in one embodiment, uses the demographic information to determine advertising targeted to the user. For example, the demographic information module 928 may receive information that a user has requested a children's movie. The demographic information module 928 may select advertising appropriate for a child in response to this information.

The ad injection module 930 injects advertising into a content module in one embodiment. The ad injection module 930 may inject advertising into static or dynamic modules. In another embodiment, advertising may be injected into a movie or music by the ad injection module 930. In certain embodiments, the ad injection module 930 injects advertisements selected in response to information in the demographic information module. Advertisements may be injected in positions selected in the ad position module 918.

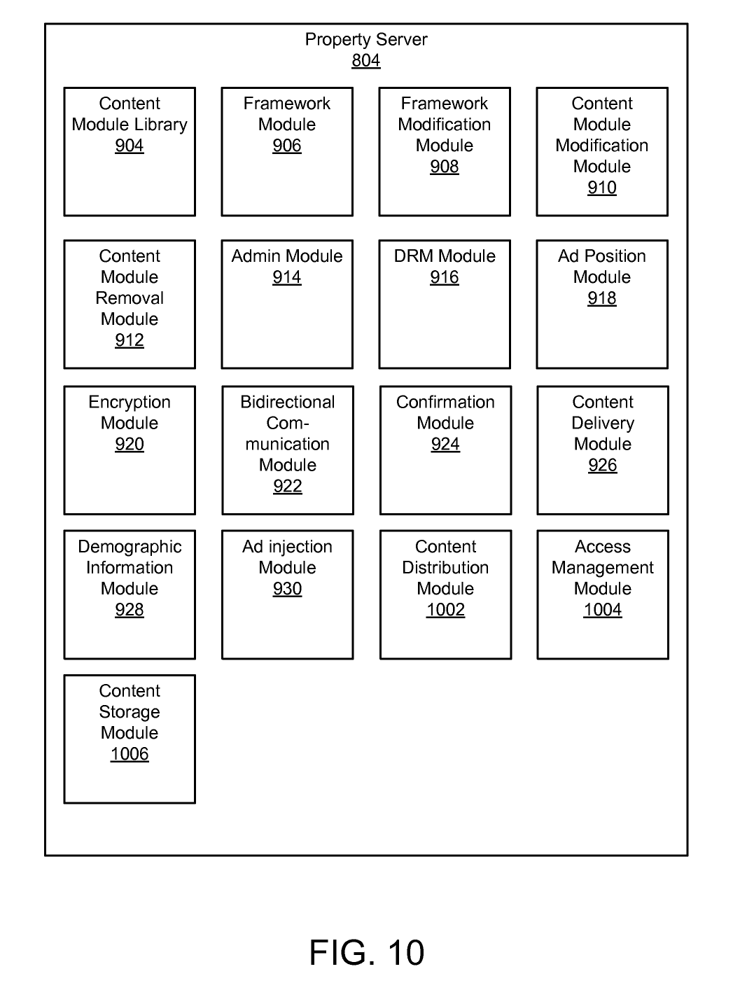

FIG. 10 illustrates one embodiment of a property server 804. In one embodiment, the property server 804 replicates many of the functions of the NOC 802. The replicated functionality of the property server 804 allows property server 804 to function autonomously if communication between the NOC 802 and property server 804 is disrupted. The property server 804 in the illustrated embodiment includes a content module library 904, a framework module 906, a framework modification module 908, a content module modification module 910, a content module removal module 912, an admin module 914, a digital rights management (DRM) module 916, an ad position module 918, an encryption module 920, a bidirectional communication module 922, a confirmation module 924, a content delivery module 926, a demographic information module 928, an ad injection module 930, a content distribution module 1002, an access management module 1004, and a content storage module 1006. The property server 804, in one embodiment, controls access to and manipulation of digital media information by one or more STBs 806.

In certain embodiments, the content module library 904, the framework module 906, the framework modification module 908, the content module modification module 910, the content module removal module 912 the admin module 914, the digital rights management (DRM) module 916, the ad position module 918, the encryption module 920, the bidirectional communication module 922, the confirmation module 924, the content delivery module 926, the demographic information module 928, and the ad injection module 930 are configured in a like manner to like numbered components described in relation to FIG. 9. The similar modules at the property server 804 level may have access to a different set of data than the modules at the NOC 802.

The content module library 904 contains references to one or more content modules in one embodiment. The content module library 904 provides access to digital media information available for distribution to end users. The content modules contained in or referenced by the content module library 904 may include, but are not limited to, digital content players, such as a video player, a link to another content module, a framework definition, an interactive application, such as a word processor or a web browser, an input screen, a text display screen, an interactive module, a non-interactive module, or the like. The content module library 904 at the property server 804 may include different content modules than the content module library 904 at the NOC 802. For example, the NOC 802 content library module 904 may include content modules pertaining to different properties which are not replicated in the local property server 804.

The framework module 906, in one embodiment, assembles one or more content modules into a framework definition. The framework module 906 accesses the content module library 904 to allow an administrator or a process to select content modules for inclusion in the framework. The framework module 806 stores the assembled framework in the content module library 904 in one embodiment.

The framework contains information defining how content modules are displayed in a GUI, such as the position and properties of the displayed content module. The framework may comprise any type of object capable of defining how content modules are displayed. For example, in one embodiment, the framework comprises an extensible markup language (XML) document.

The framework modification module 908, in one embodiment, selectively includes content modules in a framework in response to input from an administrator or process. In certain embodiments, the framework modification module 908 includes an interface that receives input from an administrator. For example, the framework modification module 908 may comprise a browser interface. The browser interface may include a drag and drop GUI allowing the administrator to drag content modules to the framework, to move modules within the framework, and to drag content modules from the framework. An administrator at the property server 804 may have different access rights than an administrator at the NOC 802, and may be restricted to access to a limited number of content module for modification by this module.

In one embodiment, the content module modification module 910 allows an administrator to selectively modify a content module. For example, a content module that includes a description of a property may be modified through the content module modification module 910 to change the description of the property. In another embodiment, the content modification module 910 creates a new content module in response to input from an administrator or process. For example, the content module modification module 810 may provide an interface for creating and adding elements to an interactive content module and add the new content module to the content module library 904. An administrator at the property server 804 may have different access rights than an administrator at the NOC 802, and may be restricted to access to a limited number of content module for modification by this module.

The content module removal module 912, in one embodiment, removes a content module from a framework in response to input from an administrator or process. For example, a framework may include a content module indicating a special price for menu items at a restaurant at a property. The content module may include an expiration date that triggers a process to activate the content module removal module 912 to remove the content module from the framework on the expiration date. An administrator at the property server 804 may have different access rights than an administrator at the NOC 802, and may be restricted to access to a limited number of content module for modification by this module.

In another embodiment, the content module removal module 912 removes a content module from the content module library 904. For example, an administrator may conclude that a content module is no longer useful, and activate the content module removal module 912 to remove the content module from the content module library 904. An administrator at the property server 804 may have different access rights than an administrator at the NOC 802, and may be restricted to access to a limited number of content module for modification by this module.

The admin module 914, in one embodiment, allows an administrator to access the modules of the property server 804. In one embodiment, the admin module 914 allows access in response to a security credential, such as a password. The admin module 914 may provide a GUI for access to modules of the property server 804. In one embodiment, the admin GUI is a browser interface.

In certain embodiments, the admin module 914 manages access to elements of the property server 804 at user and group levels. As will be appreciated by one skilled in the art, the admin module 914 may selectively allow access to elements of the property server 804 based on the access rights of the user or the user's group.

The DRM module 916, in one embodiment, manages access to digital media having access managed by digital rights. For example, a movie may include DRM requirements to limit the playback of the movie to authorized players. In certain embodiments, the DRM module 916 may cooperate with an end user display to allow access to the digital media information in response to a purchase of rights to view the digital media information. In another embodiment, the DRM module 916 may allow display of the digital media information in response to an agreement by an end user to view advertisements with the digital media information.

In one embodiment, the DRM module 916 manages one or more decryption keys used for decrypting encrypted digital media information. For example, an STB 806 may request a decryption key from the property server 804. In one embodiment, the DRM module 916 determines if the request should be granted, and delivers a decryption key to the STB 806.

The ad position module 918 selects a position for one or more advertisements in a content module in response to input from an administrator or a process. A position for an advertisement may be a location on a static or interactive screen. Additionally, a position for an ad may comprise an elapsed playback time in digital media. For example, an administrator may direct the ad position module 918 to select eighteen minutes and seven seconds as a time in a movie to place an advertisement. In another example, a process may direct the ad position module 918 to select a position in a content module displaying a GUI to an end user to display a banner ad at the top of the GUI.

The encryption module 920, in one embodiment, encrypts digital media information to restrict the display of the information to authorized viewers. The encryption may comprise any encryption method known in the art, such as public key encryption. Encrypted digital media information may require that the player include a decryption key obtained from the DRM module 916.

In one embodiment, the bidirectional communication module 922 manages communication between the property server 804 and the NOC 802. In certain embodiments, the bidirectional communication module 922 manages communication between the property server 804 and the one or more set top boxes 806. The bidirectional communication module 922 may use any communication method known in the art, such as an Ethernet connection. In one embodiment, the bidirectional communication module 922 communicates with the NOC 802 via a virtual private network (VPN) over the Internet.

The bidirectional communication module 922, in one embodiment, transmits information including but not limited to media requests by end users, billing information from end users and properties, performance data, error data, and the like. In addition, the bidirectional communication module 922 transmits information to the NOC 802 and STBs 806 including, but not limited to new frameworks, modified frameworks, content modules, digital media information, pricing information, and the like.

In one embodiment, the confirmation module 924 receives confirmation from a user to access a content module. Confirmation may take the form of a personal identification number (PIN), a credit card number, the swiping of a credit card in a card reader, a swipe of a room key in a card reader, or the like. By receiving confirmation in conjunction with delivering digital content, the confirmation module 924 reduces the incidence of charge backs. For example, a user may request a pay movie. The confirmation module 924 requires that the user enter a PIN to confirm the purchase of the movie, thus reducing the likelihood of “accidental” purchases and requests for a charge back.

The content delivery module 926 delivers digital media information. In one embodiment, the content delivery module 926 delivers digital media information to one or more STBs 806. In one embodiment, the content delivery module 926 may deliver digital media information by streaming digital content. For example, the content delivery module 926 may stream a requested movie for playback by an STB 806.

The demographic information module 928, in one embodiment, receives demographic information. The demographic information may include information about an end user, information about a property, information about content being viewed, or the like. For example, an end user may request a movie, and the demographic information module 928 may receive the age of the user, the zip code of the property where the user is located, and information about the type of movie being viewed.

The demographic information module 928, in one embodiment, uses the demographic information to determine advertising targeted to the user. For example, the demographic information module 928 may receive information that a user has requested a children's movie. The demographic information module 928 may select advertising appropriate for a child in response to this information.

The ad injection module 930 injects advertising into a content module in one embodiment. The ad injection module 930 may inject advertising into static or dynamic modules. In another embodiment, advertising may be injected into a movie or music by the ad injection module 930. In certain embodiments, the ad injection module 930 injects advertisements selected in response to information in the demographic information module. Advertisements may be injected in positions selected in the ad position module 918.

The content distribution module 1002, in one embodiment, delivers digital media information to one or more property servers. In one embodiment, the content distribution module 1002 uses a peer-to-peer protocol. For example, the content distribution module 1002 may deliver a new movie using a BitTorrent™ protocol to a plurality of property servers 804. For example, a new movie title may be distributed in sections to a plurality of property servers 804. The individual property servers share the sections of the movie title over the peer-to-peer protocol such that the network traffic is distributed among the property servers 804.

The access management module 1004, in one embodiment, manages access and manipulation of the digital media information for display at an end user display. The access management module 1004 allows access to content modules based on user rights granted to the end user. User rights may be granted based on subscriptions, individual purchases, or on other bases as known in the art. The access management module may interact with other modules, such as the DRM module 916, the confirmation module 924, and the demographic information module 928 to determine the circumstances for granting access to a content module.

In one embodiment, the content storage module 1006 stores digital media information for delivery to one or more STBs 806. The content storage module 1006 may store the digital media information using any media storage system known in the art. For example, the property server 804 may store a movie on a hard disk drive connected to the property server 804.

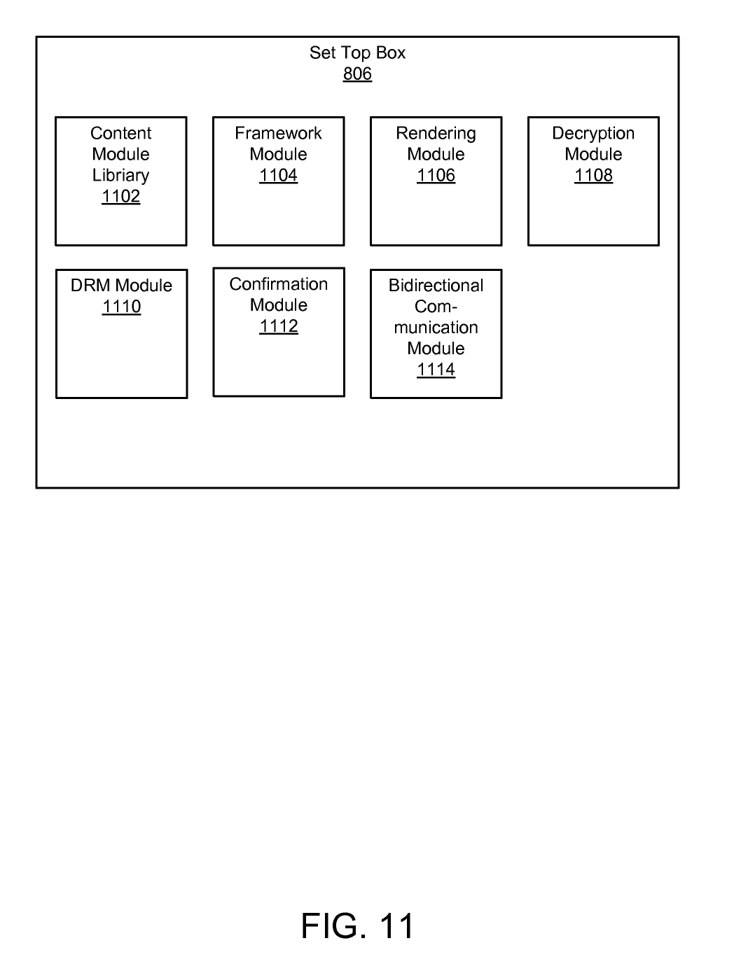

FIG. 11 illustrates one embodiment of a set top box (STB) 806. The STB 806 includes a content module library 1102, a framework module 1104, a rendering module 1106, a decryption module 1108, a DRM module 1110, a confirmation module 1112, and a bidirectional communication module 1114. The STB 806 drives an end user display and displays a GUI.

The content module library 1102 contains one or more content modules in one embodiment. The content module library 1102 provides access to digital media information available for display on the STB 806. The content modules contained in or referenced by the content module library 1102 may include, but are not limited to, digital content players, such as a video player, a broadcast or cable television programming display, a link to another content module, a framework definition, an interactive application, such as a word processor or a web browser, an input screen, a text display screen, an interactive module, a non-interactive module, or the like.

The content module library 1102 may include content modules for required for many framework definitions, or for a single framework definition in one embodiment. For example, the content module library 1102 may include only the content modules for the current framework definition, and may remove unneeded modules when a new framework definition is accessed. In another example, the content module library may retain a cache of previously accessed content modules.

The framework module 1104, in one embodiment, retrieves a framework definition that defines a display. The framework definition contains information defining how content modules are displayed in a GUI, such as the position and properties of the displayed content module. The framework definition may comprise any type of object capable of defining how content modules are displayed. For example, in one embodiment, the framework definition comprises an extensible markup language (XML) document.

In one embodiment, the rendering module 1106 renders a display in response to a framework definition. The framework definition is interpreted by the rendering module 1106 to determine the position and presence of content modules on a display. The rendering module 1106, in certain embodiments, displays digital media information from a content module. For example, the framework definition may include a content module configured to display a video. The rendering module 1106 displays the video on a display in this example.

The decryption module 1108 decrypts encrypted content in one embodiment. The decryption module 1108 may access a decryption key for performing decryption. In one embodiment, the decryption module 1108 retrieves a decryption key from the property server 804. In another embodiment, the decryption module 1108 retrieves a decryption key from the NOC 802. The decryption module 1108 may use any form of decryption known in the art.

The DRM module 1110 manages the playback of digital media information protected by digital rights. The DRM module 1110 includes licenses assigned to the end user for content, in one embodiment. The DRM module 1110 may communicate with the property server 804 or the NOC 802 to access and manage licenses for media.

The confirmation module 1112, in one embodiment, confirms the selection of a content module by an end user. The confirmation module 1112 may include an input component for receiving a confirmation, such as an interactive screen, a card reader, or the like. The confirmation module 1112, in one embodiment, receives input confirming selection of the content module and transmits the confirmation input to the property server 804 and/or the NOC 802. In one example, the confirmation module 1112 includes a credit card reader. The end user, in this example, causes a credit card to be read by the card reader to confirm the selection of a pay movie. The confirmation module 1112 sends the credit card information read by the credit card reader to the property server to confirm purchase of the pay movie.

The bidirectional communication module 1114, in one embodiment, transmits and receives information for the STB 802. In one embodiment, the bidirectional communication module 1114 manages communication between the STB 1106 and the NOC 802. In certain embodiments, the bidirectional communication module 1114 manages communication between the property server 804 and the one or more set top boxes 806. The bidirectional communication module 1114 may use any communication method known in the art, such as an Ethernet connection.

The bidirectional communication module 1114, in one embodiment, transmits information including but not limited to media requests by end users, billing information from end users and properties, performance data, error data, and the like. In addition, the bidirectional communication module 1114 receives information from the NOC 802 and property server 804 including, but not limited to new frameworks, modified frameworks, content modules, digital media information, pricing information, and the like.

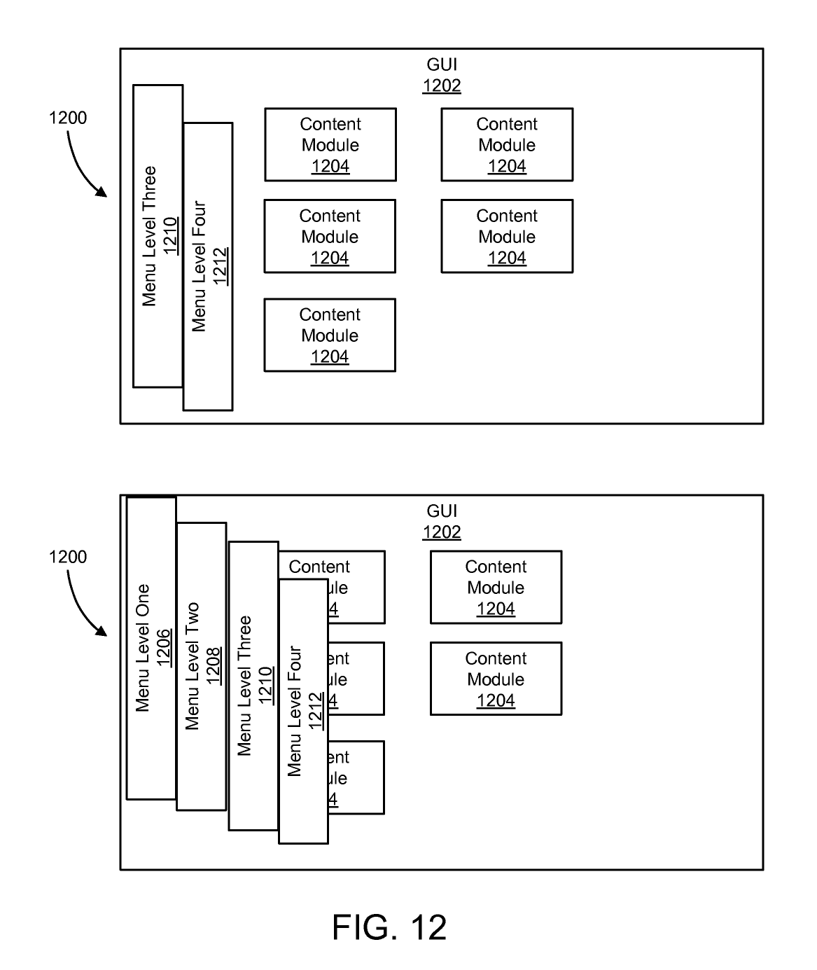

FIG. 12 illustrates one embodiment of a partially retracting hierarchical menu 1200. The partially retracting hierarchical menu 1200 includes a GUI 1202, one or more content modules 1204, and one or more levels 1206, 1208, 1210, and 1212 of hierarchical menus. The partially retracting hierarchical menu 1200 provides easy access to menus while maximizing screen real estate in the GUI 1202.

The GUI 1202, in one embodiment, is generated from a framework definition by an STB 806. The GUI 1202 includes one or more content modules 1204 configured to display digital media information. The GUI 1202 may also include a partially retracting hierarchical menu 1200 comprising one or more levels 1206, 1208, 1210, and 1212 of hierarchical menus.

The partially retracting hierarchical menu 1200, in one embodiment, retracts when a hierarchical menu level is not highlighted. In certain embodiments, only the bottom two levels of the hierarchical menu 1210, 1212 are displayed, while the levels above the bottom two levels 1206, 1208 are hidden. By hiding upper level menus, more modules 1204 are visible in the GUI 1202 while still providing context information provided by the visible, lower menu levels 1210, 1212.

As shown in FIG. 12, the partially retracting hierarchical menu 1200 extends when a menu level is highlighted in one embodiment. The extension of the partially retracting hierarchical menu 1200 may obscure one or more content modules 1204 in the GUI 1202, but provide easy access to more levels 1206, 1208, 1210, and 1212 of the hierarchical menu.

For example, the hierarchical menu may include “main,” “property info,” “dining,” and “coffee shop” as hierarchical menu levels one 1206, two 1208, three, 1210, and four 1212, respectively. The partially retractable hierarchical menu 1200 may display “dining” and “coffee shop” when accessing the coffee shop GUI 1202 while hiding “main” and “property info” when a menu level is not selected. In this example the partially retracting hierarchical menu 1200 may extend to show “main” and “property info” in addition to “dining” and “coffee shop” in response to an end user selecting the “coffee shop” menu level.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

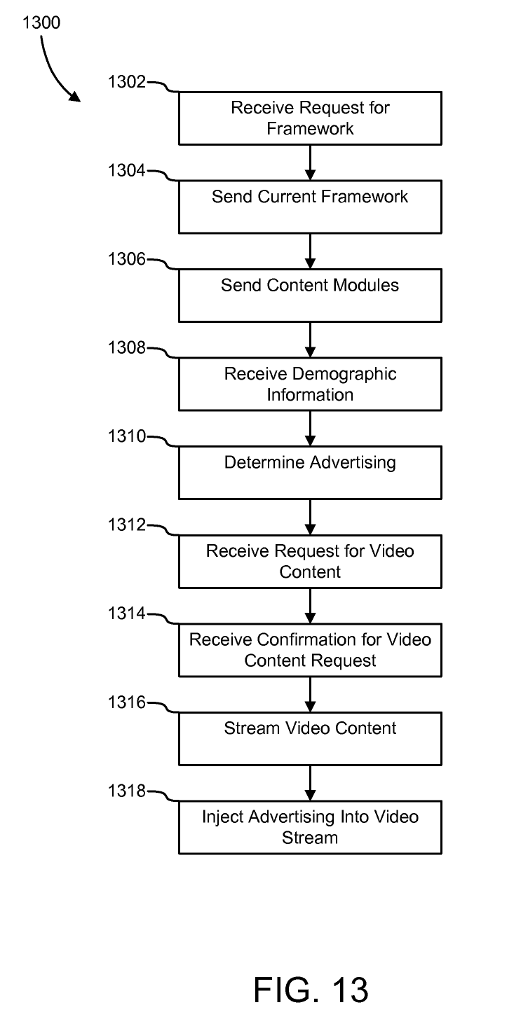

FIG. 13 is a flow chart diagram showing the various steps of a method 1300 for distributing digital media information. The method 1300 is, in certain embodiments, a method of use of the system and apparatus of FIGS. 1-12, and will be discussed with reference to those Figures. Nevertheless, the method 1300 may also be conducted independently thereof and is not intended to be limited specifically to the embodiments discussed above with respect to those Figures.

As shown in FIG. 13, a request for a framework definition is received 1302. The request may be received by a property server 804 or by a NOC 802. A framework definition may be requested in response to each content display request. The receiver sends 1304 the current framework definition. Since the request for a framework definition takes place in response to each content request, changes to the current framework definition are dynamically delivered to the requester as soon as the changes are stored to the sender.

A content delivery module 926 sends content modules associated with the requested framework. The content modules provide access to digital media information. A demographic information module 928 receives 1306 demographic information relating to the end user. The demographic information may include, but is not limited to, information about the end user, the location of the display device, and the type of content being accessed.

The demographic information module 928 determines 1310 advertising to display to the end user. Determining 1310 advertising may be in response to the demographic information received 1308 by the demographic module 928.

In one embodiment, a bidirectional communication module 922 receives 1312 a request for video content. The request for video content may be triggered by activation of a content module sent 1306 in relation to the framework. A confirmation module 924 may receive 1314 confirmation for the video content. Confirmation may be required in order to deliver content.

The content delivery module 924 may stream 1316 video content in response to receiving 1312 a request for the content and receiving 1314 a confirmation of the request. The video may be streamed to the end user using any streaming method known in the art.

In one embodiment, an ad injection module 930 injects 1318 advertising into the streamed video content. The advertising may be in response to other inputs, such as demographic information, content module, and confirmation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to distribute digital media information to an end user through: individual modules, the apparatus comprising:
a central networked data point controlling access to and manipulation of the digital media information for display at an end user display;
one or more content modules, the one or more content modules providing access to digital media information at the end user display;
a framework module configured to assemble the one or more content modules into a framework definition forming a graphical user interface (GUI) for the end user display;
a framework modification module configured to selectively include content modules in the framework definition.

2. The apparatus of claim 1, wherein the central networked data point and the end user display engage in bidirectional communication.

3. The apparatus of claim 1, further comprising a property server comprising:
an access management module configured to manage access and manipulation of the digital media information for display at an end user display;
a content storage module configured to store digital media information for display at an end user display;
wherein the property server is configured to service one or more end user displays, the one or more end user displays exclusively located at a multiple dwelling unit (MDU).

4. The apparatus of claim 3 wherein the property server further comprises a content distribution module configured to distribute a portion of a title of digital media content to another property server using a peer-to-peer protocol.

5. The apparatus of claim 4 wherein the property server cooperates with a plurality of property servers to distribute the digital media content.

6. A system to distribute digital media information to an end user through individual modules, the system comprising:
a network operations center (NOC) controlling access to and manipulation of the digital media information;
a property server configured to service one or more end user displays, the one or more end user displays exclusively located at a multiple dwelling unit (MDU), the property server in bidirectional communication with the NOC, the property server configured to:
receive digital media information from the NOC;
transmit usage data to the NOC;
transmit digital media information to a set top box (STB); and
receive media requests from the STB; and
a set top box (STB) in bidirectional communication with the property server. the STB configured to:
retrieve a framework definition comprising one or more content modules from the property server;
display a graphical user interface (GUI) providing user access to the content modules in the framework;
transmit media requests to the property server; and
display the digital media information accessed by the content modules.

7. The system of claim 6, wherein the NOC and the property server communicate over the Internet using a virtual private network (VPN).

8. The system of claim 6, wherein the STB retrieves the framework definition from the property server in response to each content display request.

9. A computer program product comprising a computer readable medium having computer usable program code executable to perform operations for distributing digital media information to an end user through individual modules, the operations of the computer program product comprising:
accessing a dynamic framework definition in response to each content display request, the dynamic framework definition defining a graphical user interface (GUI), the dynamic framework definition accessed from a property server configured to service one or more end user displays, the one or more end user displays exclusively located at a multiple dwelling unit (MDU);
interpreting the dynamic framework definition to determine the presence and position of one or more content modules;
rendering a display comprising one or more content modules; and
accessing digital media information in response to the activation of a content module.

10. The computer program product of claim 9, further comprising accessing a second dynamic framework definition in response to the activation of a content module, the second dynamic framework definition accessed from the property server.

11. The computer program product of claim 9, wherein rendering the display includes displaying a partially retracting hierarchical menu wherein the partially retracting hierarchical menu retracts to display only two or more bottom levels of a menu hierarchy.

12. The computer program product of claim 11, wherein the partially retracting hierarchical menu extends to display three or more levels of a menu hierarchy in response to highlighting an element of the partially retracting hierarchical menu.

13. The computer program product of claim 9, wherein accessing digital media information includes decrypting the digital media information using a decryption key.

14. The computer program product of claim 9, wherein the dynamic framework definition is an extensible markup language (XML) document.

15. The computer program product of claim 9, wherein the each of the one or more content modules is selected from the group consisting of a digital content player, a link to a second dynamic framework definition, an interactive application, an input screen, and a text display screen.

16. A method for distributing digital media information to an end user through individual modules, the method comprising:
delivering a framework to an end user display comprising one or more content modules;
delivering a content module to an end user, the content module configured to display video content in response to activation by the end user;
streaming the video content to the end user in response to activation of the content module by the end user;
selecting a position for an advertisement in the video content;
selecting the advertisement based on demographic information; and
injecting the advertisement into the streamed video content.

17. The method of claim 16, further comprising receiving demographic information relating to the end user, and wherein selecting the advertisement based on demographic information further comprises selecting the advertisement based on demographic information relating to the end user.

18. The method of claim 16, wherein selecting the advertisement based on demographic information further comprises selecting the advertisement based on information relating to the location of the end user display.

19. The method of claim 16, wherein selecting the advertisement based on demographic information further comprises selecting the advertisement based on information relating to the video content.

20. The method of claim 16, wherein selecting a position for an advertisement in the video content further comprises receiving input from an administrator indicating a desired position for the advertisement in the video content.

21. The method of claim 16, wherein streaming the video content to the end user is in response to an activation confirmation by the end user.

22. The method of claim 21 wherein the activation confirmation is selected from the group consisting of input of a personal identification number (PIN), a credit card number, a swipe of a credit card in a credit card reader, and a swipe of a room key in a room key reader.

23. An apparatus to distribute digital media information to an end user through individual modules, the apparatus comprising:
a central networked data point controlling access and manipulation of the digital media information for display at an end user display;
one or more content modules, the one or more content modules providing access to digital media information at the end user display;
wherein the each of the one or more content modules is selected from the group consisting of a digital content player, a link to a second dynamic framework definition, an interactive application, an input screen, and a text display screen;
a framework module configured to assemble the one or more content modules into a framework forming a graphical user interface (GUI) for the end user display; and
a framework modification module configured to selectively include content modules in the framework.

24. The apparatus of claim 23 wherein the framework modification module further comprises:
a browser interface configured to accept input from an administrator;
a content module library configured to contain references to one or more content modules, the references configured to be added to the framework in response to input by the administrator; and
a content module removal module configured to remove a content module from the framework in response to input by the administrator.

25. The apparatus of claim 24 further comprising a content module modification module configured to create a content module in response to input by the administrator.
